(19) United States
(12) Patent Application Publication
(10) Pub. No.: US 2023/0003537 A1
(43) Pub. Date: Jan. 5, 2023

(54) METHOD AND SYSTEM FOR REGULATING TRAFFIC EMISSIONS ACROSS A STREET NETWORK

(71) Applicants: HYUNDAI MOTOR COMPANY, SEOUL (KR); KIA CORPORATION, SEOUL (KR)

(72) Inventors: Andreas Kapp, Eschborn (DE); Viktor Boschmann, Albisheim (DE); Bastian Unterberger, Niederwallmenach (DE); Ernst Mohs, Waldalgesheim (DE); Christelle Rodier, Trebur (DE); Mohamed Boughardain, Dietzenbach (DE); Thilo Tümmers, Schwanheim (DE); Stefan Hoffmann, Riedstadt (DE); Leonardo Canzio, Weiterstadt (DE)

(21) Appl. No.: 17/523,376

(22) Filed: Nov. 10, 2021

(30) Foreign Application Priority Data
Jul. 1, 2021 (DE) 102021003396.5

(51) Int. Cl. G01C 21/34; G08G 1/01

(52) U.S. Cl. CPC G01C 21/3469; G08G 1/0112

(57) ABSTRACT

A method for regulating traffic emissions across a street network comprises calculating, by an external control entity, a real-time location-dependent immission load across the street network based on at least one of environmental data, traffic data and configuration data of the street network, providing, by motor vehicles using the street network, navigation data characterizing a route of each respective motor vehicle along the street network and emission data characterizing exhaust emission levels of each respective motor vehicle along its route, and calculating an optimized driving route for each motor vehicle along the street network based on the calculated immission load and the exhaust emission levels of the motor vehicles. The optimized driving route is calculated by the external control entity and transmitted to each motor vehicle via a wireless communication network, or wherein the optimized driving route is calculated by an internal control unit of each respective motor vehicle.

### CROSS REFERENCE TO RELATED APPLICATIONS

The present application claims priority to German Patent Application No. 102021003396.5, filed Jul. 1, 2021, the entire contents of which is incorporated herein for all purposes by this reference.

### TECHNICAL FIELD

The present disclosure pertains to a method and a system for regulating traffic emissions across a street network.

### BACKGROUND

Traffic emissions constitute a major source of health hazardous air pollution in urban areas. Models describing pollutant levels in urban streets are thus important tools in air pollution management as a supplement to measurements in routine monitoring programs. A widely used model in this context is the fast and easy to apply Operational Street Pollution Model (OSPM). The model is capable of calculating airborne concentrations of exhaust gases emitted by motor vehicles within a street canyon. For almost 20 years, OSPM has been routinely used in many countries for studying traffic pollution, performing analyses of field campaign measurements, studying efficiency of pollution abatement strategies, carrying out exposure assessments and as reference in comparisons to other models. OSPM is generally considered as state-of-the-art in practical street pollution modelling.

Usually, traffic emissions are not evenly distributed over a city area but mainly occur on main streets and selected spots across the city. Pollutant concentrations (e.g. NO₂) may therefore exceed in these selected regions the air quality limits imposed by the respective authorities, which may result in driving restrictions or even bans for certain vehicles. Hence, there is a need to distribute traffic emissions more homogenously over a street network.

CN 108871362 A describes a dynamic environment-friendly travel path planning method for automobiles, which relies on real-time vehicle emission data and an emission calculation model to assist drivers plan an emission reduced travel path in a dynamic traffic situation across an urban environment.

### SUMMARY

In light of the above, an object of the present disclosure is to find practical solutions for further reducing traffic emissions in a city environment and distributing them more homogenously.

According to one aspect of the disclosure, a method for regulating traffic emissions across a street network comprises calculating, by an external control entity, a real-time location-dependent immission load across the street network based on at least one of environmental data, traffic data and configuration data of the street network, providing, by motor vehicles using the street network, navigation data characterizing a route of each respective motor vehicle along the street network and emission data characterizing exhaust emission levels of each respective motor vehicle along its route, and calculating an optimized driving route for each motor vehicle along the street network based on the calculated immission load and the emission data of the motor vehicles, wherein the optimized driving route is calculated by the external control entity and transmitted to each motor vehicle via a wireless communication network, and/or wherein the optimized driving route is calculated by an internal control unit of each respective motor vehicle.

According to another aspect of the disclosure, a system for regulating traffic emissions across a street network comprises an external control entity configured to calculate a real-time location-dependent immission load across the street network based on at least one of environmental data, traffic data and configuration data of the street network, and motor vehicles using the street network, each motor vehicle being configured to provide navigation data characterizing a route of the respective motor vehicle along the street network and emission data characterizing exhaust emission levels of the respective motor vehicle along its route. The external control entity is configured to calculate an optimized driving route for each motor vehicle along the street network based on the calculated immission load and the emission data of the motor vehicles and to transmit the optimized driving routes to the respective motor vehicles via a wireless communication network, and/or an internal control unit of each motor vehicle is configured to calculate an optimized driving route for the respective motor vehicle along the street network based on the calculated immission load and the emission data of the motor vehicles.

One idea of the present disclosure is to combine information on current and/or predictive exhaust emissions of vehicles driving around the street network with information on current and/or predictive immission levels across the street network in order to provide a traffic emission management system that is able to distribute emissions to comply with local and/or global air quality limits such that driving bans may be avoided. To this end, the system uses intelligent guidance of each individual vehicle along the street network based on vehicle emissions and system immission load, e.g. to minimize vehicle emissions across the street network and/or to optimize local immission load/distribution.

Motor vehicles are increasingly equipped with onboard monitoring, which may be adapted for determining or estimating exhaust emissions, and/or with predictive energy management, which may allow to draw conclusions on emission levels. The data of these and similar onboard systems may be employed to provide real-time information regarding actual and/or predictive (depending on a planned route) exhaust emission levels. Vehicle connectivity, e.g. via vehicle-to-everything communication (V2X), then enables to share this information with an external control entity, e.g. a computer system, service providers, authorities etc.

The external control entity can employ a suitable model to calculate the immission load as a function of position within the street network. For example, an actual and/or predictive OSPM may be used to set up immission load maps using information such as traffic flow and/or traffic density, weather conditions, air quality measurement stations and so on. The combination of both systems, that is, vehicle emission monitoring on the one hand and immission load modelling on the other, now opens up new possibilities to regulate traffic flow and traffic emissions in a city environment by connecting both systems via data networking.

To this end, the present disclosure provides two basic strategies that can be used alternatively or in combination. One the one hand, the motor vehicle may themselves calculate emission-optimized routes based on information provided by the external control entity, e.g. a third party instance using OSPM for this purpose. On the other hand, the external control entity may calculate the emission-optimized route and may then transmit the result to the respective motor vehicle. The optimized route may be provided as recommendation, aid or specification for the driver, which he or she may follow accordingly. With the advent of assisted, autonomous and/or automatic driving however, the optimized route may also be provided as driving commands that are more or less automatically implemented by an assisted, autonomous and/or automatic driving unit of the vehicle.

Emissions are generally defined as any discharge of substances or energy from a source into the environment. The Federal Immission Control Act (Bundes-Immissionsschutzgesetz, BImSchG) defines emissions as air pollution, noise, light or vibrations originating from an installation. Immission is defined as the effects of these emissions on the environment; in the case of air pollution on people, plants, animals, materials and the atmosphere. Hence, immission may particularly be an amount, measured in different specific units, of a polluting substance present at a given time in a more or less specific location. An immission load within the meaning of the present disclosure refers to the total amount of immissions introduced at a given location and/or in a given environment.

It is understood that the term “vehicle” or “vehicular” or other similar term as used herein is inclusive of motor vehicles in general such as passenger automobiles including sports utility vehicles (SUV), buses, trucks, various commercial vehicles, and the like, and includes hybrid vehicles, plug-in hybrid electric vehicles and alternative fuel vehicles (e.g., fuels derived from resources other than petroleum). As referred to herein, a hybrid vehicle is a vehicle that has two or more sources of power, for example both gasoline-powered and electric-powered vehicles.

According to an embodiment of the disclosure, each motor vehicle may transmit the navigation data and/or the emission data to the external control entity via a wireless communication network.

For example, V2X communication may be used to transmit data between the vehicles and the external control entity. Navigation data may comprise amongst others information about the destination of the current trip of the respective vehicle. It is to be understood however that much more extensive data about the current and projected route of each vehicle may be exchanged wirelessly in real-time.

Exhaust emission levels may be expressed, for example, by means of a vehicle emission class or the like, which may generally define average emission values of each vehicle. However, exhaust emission levels may also be provided in more detail, e.g. as data of an onboard emission control and/or monitoring system, an energy management system or the like. The data may particularly comprise measurement data describing the emissions of each vehicle in real-time including projected values for the planned route along the street network.

According to an embodiment of the disclosure, the external control entity may transmit information about the calculated immission load to each vehicle via the wireless communication network.

For example, the control entity may inform each vehicle about current and/or projected emission zones/areas within the street network defining limits on the allowed emissions and/or modes of operation of the vehicles, which may vary depending on the type of vehicle, the time, the weekday, the date etc. Such zones do not necessarily have to be fixed but may change dynamically depending on the current or anticipated immission situation across the street network, on the current or anticipated traffic flow along the network and/or on current regulations.

According to an embodiment of the disclosure, the optimized driving routes of the motor vehicles may be calculated taking into account a variable operation mode of the respective vehicle and/or a battery status of a traction battery of the respective vehicle.

For example, a plug-in hybrid may be operated in electric mode depending on the route and the state of charge of the respective battery in order to keep emission as low as possible. In certain city areas or emission zones electric driving may even be required as ICE (internal combustion engine) driving may be prohibited at least under certain conditions, times of the day etc.

However, variable operation modes within the meaning of the present disclosure may comprise more general modes for operating a motor vehicle including, for example, speed profiles and/or maximum speeds.

According to an embodiment of the disclosure, the motor vehicles may be provided with an optimized operation scheme to be followed on the optimized driving route.

For example, the external control entity may inform each vehicle about an optimized route including a recommended operation mode, which may change along the route. In one particular example, the external control entity may request the vehicles to drive below a certain maximum speed. In another specific example, the external control entity may only allow electric driving.

Operation modes and/or operation schemes may depend on the location within the street network, e.g. based on predefined or dynamically defined emission zones or areas that divide the street network or parts of the street network into smaller subareas with different regulation with regards to allowed emission levels, immission loads and/or allowed operating modes.

According to an embodiment of the disclosure, the optimized driving routes of the motor vehicles may be calculated to minimize the immission load and/or to keep the immission load below a predefined threshold at least in predefined emission zones of the street network.

The external control entity may for example calculate an optimal traffic distribution for the street network based on current and/or predicted air quality and other factors. Based on the result, specific emission zones may be defined that specify the allowable emission levels in the respective region of the street network (e.g. maximum allowed emission, zero emission etc.). The external control entity may then run a route optimization algorithm for each vehicle that reduces and/or minimizes immissions, in particular air pollution, in the emission zones (e.g. with respect to PM, NOx, CO₂ and so on). The information transmitted to each vehicle may then not only comprise the optimal route but in addition also operation modes, speed profiles, requests for electric or ICE driving etc.

The disclosure will be explained in greater detail with reference to exemplary embodiments depicted in the drawings as appended.

### BRIEF DESCRIPTION OF THE FIGURES

The accompanying drawings are included to provide a further understanding of the present disclosure and are incorporated in and constitute a part of this specification. The drawings illustrate the embodiments of the present disclosure and together with the description serve to explain the principles of the disclosure. Other embodiments of the present disclosure and many of the intended advantages of the present disclosure will be readily appreciated as they become better understood by reference to the following detailed description. The elements of the drawings are not necessarily to scale relative to each other. In the figures, like reference numerals denote like or functionally like components, unless indicated otherwise.

FIG. 1 schematically depicts a motor vehicle driving through a street network, which is controlled by a system for regulating traffic emissions according to an embodiment of the disclosure.

FIG. 2 schematically shows the system used in FIG. 1.

FIG. 3 shows a flow diagram of a method for regulating traffic emissions with the system of FIG. 2.

Although specific embodiments are illustrated and described herein, it will be appreciated by those of ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein.

### DETAILED DESCRIPTION

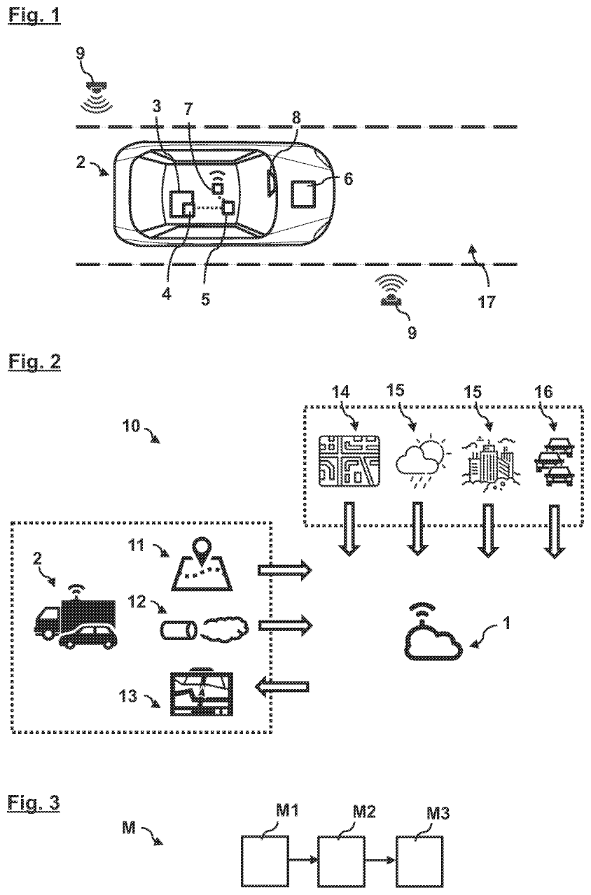

FIG. 1 schematically depicts a motor vehicle 2 driving through a street network 17, which is controlled by a system 10 for regulating traffic emissions according to an embodiment of the disclosure. FIG. 2 schematically shows the system 10 used in FIG. 1, while FIG. 3 depicts a flow diagram of a method M for regulating traffic emissions with the system 10 of FIG. 2. The street network 17 may be, for example, an urban area with increased traffic in at least certain subareas or hotspots, e.g. main streets, cross roads, highways etc. The street network 17 may thus be subject to traffic congestion problems and the related air quality problems due to emissions of internal combustion engines of the vehicles.

The presently described method M and system 10 improve this situation by providing an online traffic guidance to optimize traffic flow, to minimize emission hot spots and to distribute immission load over the whole city area (that is, the street network 17) more homogenously in order to comply with the stringent air quality limits imposed in certain European and/or worldwide regions and to reduce total greenhouse gas and harmful emissions. The present concept may particularly help to avoid driving bans in heavily frequented urban areas.

To this end, the system 10 comprises an external control entity 1, e.g. a computing center, service provider and/or authority of the respective city, which is configured to calculate a real-time current and/or predictive location-dependent immission load across the street network 17 based on various relevant data including but not limited to environmental data 15, traffic data 16, and configuration data 14 of the street network 17.

The external control entity 1 may employ an Operational Street Pollution Model (OSPM) for the above purpose, e.g. to calculate actual and/or predictive immission load maps using information such as traffic flow and density, weather condition and air quality measurement stations. It is to be understood however that the external control entity 1 may also use other suitable models or computational approaches to calculate or estimate the immission load of the street network 17.

Environmental data 15 may comprise, for example, real-time information about the current or anticipated weather, climate, smog and/or pollution levels along the streets of the street network 17 and so on. These data may include measurements conducted across the street network 17 via corresponding measurement/sensing equipment. As an example, FIG. 1 shows two environment sensors 9 to illustrate this aspect.

Configuration data 14 of the street network 17 may comprise any relevant information on the street network 17, e.g. street arrangement, street geometries, street constants, road blockings and/or construction sites and so on.

Traffic data 16 may comprise any information defining the current or anticipated traffic situation across the street network 17, e.g. traffic flow, congestions, accidents etc.

The external control entity 1 may be communicatively coupled to motor vehicles 2 using the street network 17, e.g. via wireless V2X communication. The motor vehicles 2 may also use this or another network to communicate with each other.

Each motor vehicle 2 is configured to provide navigation data 11 characterizing a route of the respective motor vehicle 2 along the street network 17, e.g. destinations, and emission data 12 characterizing exhaust emission levels of the respective motor vehicle 2 along its route, e.g. vehicle emission class, current and/or predictive exhaust emission levels etc. The vehicles 2 may provide real-time information on these aspects by employing an onboard monitoring system and/or predictive energy management system, which may be coupled or integrated in an assisted/autonomous/automatic driving system of the respective vehicle 2.

By way of example, FIG. 1 shows a plug-in hybrid vehicle 2 having an internal combustion engine 6 and an electric-vehicle battery 3 controlled by a battery control unit 4, which in turn is communicatively coupled to an internal control unit 5 of the vehicle 2. The internal control unit 5 may be part of and/or be coupled to an onboard monitoring system, predictive energy management system and/or assisted/autonomous/automatic driving system of the vehicle 2 as mentioned above. The internal control unit 5 is connected to a communication unit 7 of the vehicle 2, which is configured to connect to a wireless network in order to exchange the navigation data and the emission data with the external control entity 1. The external control entity 1 in turn may provide the vehicle 2 with information about the calculated immission load via the wireless network.

The system 10 now provides two strategies for using the above information from the external control entity 1 and the motor vehicles 2 to regulate the traffic flow across the street network 17 such that it becomes more homogenous and emission hot spots are suppressed or completely avoided. It will be clear to the person of skill in the following that both approaches may also be combined with each other.

On the one hand, the external control entity 1 may be configured to calculate an optimized driving route 13 for each motor vehicle 2 along the street network 17 based on the calculated immission load and the emission data of the motor vehicles 2 and to transmit the optimized driving routes 13 to the respective motor vehicles 2 via a wireless communication network. The optimized driving routes 13 may be provided as driving recommendations for manually driven vehicles and may be displaced to the driver on a driver interface 8, e.g. on a display on a dashboard or the like. In case of autonomous or automatic driving, the optimized driving routes 13 may be provided as driving commands, which are then implemented by the respective system of each vehicle 2.

On the other hand, the internal control unit 5 of each motor vehicle 2 may be configured to calculate an optimized driving route 13 for the respective motor vehicle 2 along the street network 17 based on the calculated immission load and the emission data of the motor vehicles 2. Hence, in that case the vehicles 2 themselves may be responsible for the calculation of the optimal route. In that case, the external control unit 1 may merely provide relevant information about the immission load required to determine an optimized route.

The optimized driving routes 13 of the motor vehicles 2 can be calculated to minimize the immission load and/or to keep the immission load below a predefined threshold at least in predefined emission zones of the street network 17. For example, a route optimization may be performed to reduce air pollution across the street network 17 or at least in certain zones of the network 17, e.g. with respect to particulate, matter, nitrogen oxides and so on.

The corresponding method M shown on FIG. 3 may comprise under M1 calculating, by the external control entity 1, the real-time location-dependent immission load across the street network 17 based on at least one of environmental data 15, traffic data 16 and configuration data 14 of the street network 17. The method M may further comprise under M2 providing, by the motor vehicles 2 using the street network 17, navigation data 11 characterizing a route of each respective motor vehicle 2 along the street network 17 and emission data 12 characterizing exhaust emission levels of each respective motor vehicle 2 along its route. The method M may further comprise under M3 calculating the optimized driving route 13 for each motor vehicle 2 along the street network 17 based on the calculated immission load and the emission data of the motor vehicles 2.

The optimized driving routes 13 of the motor vehicles 2 may generally be calculated taking into account a variable operation mode of each motor vehicle 2 and/or a battery status of a traction battery 3 of the respective motor vehicle 2. The motor vehicles 2 may then be provided with an optimized operation scheme to be followed on the optimized driving route 13. For example, the vehicles 2 may follow a certain optimized route together with a corresponding sequence of specified operation modes, e.g. a certain speed profile and/or requests for electric driving instead of ICE driving. Different emission zones may be defined along the route of each vehicle 2, which may impose certain restrictions, e.g. on ICE driving, so that the operation mode may depend on the current emission zone.

As a result, a traffic guidance is provided that helps to minimize emission hot spots and to distribute immission load over an urban area more homogenously to comply with stringent air quality limits in Europe/worldwide, to reduce total greenhouse gas and harmful emissions and to avoid driving bans. The present approach may help to improve overall air quality inside cities, thereby improving the quality of life of urban residents.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents of the different features and embodiments. Many other examples will be apparent to one skilled in the art upon reviewing the above specification. The embodiments were chosen and described in order to explain the principles of the disclosure and its practical applications, to thereby enable others skilled in the art to utilize the disclosure and various embodiments with various modifications as are suited to the particular use contemplated.

1. A method for regulating traffic emissions across a street network, the method comprising:
calculating, by an external control entity, a real-time location-dependent immission load across the street network based on at least one of environmental data, traffic data and configuration data of the street network;
providing, by a plurality of motor vehicles using the street network, navigation data characterizing a route of each of the plurality of motor vehicles along the street network, and emission data characterizing exhaust emission levels of each of the plurality of motor vehicles along a route; and
calculating an optimized driving route for each of the plurality of motor vehicles along the street network based on the calculated immission load and the emission data of the plurality of motor vehicles;
wherein the optimized driving routes are calculated by the external control entity and transmitted to each of the plurality of motor vehicles via a wireless communication network; or
wherein the optimized driving routes are calculated by an internal control unit of each of the plurality of motor vehicles.

2. The method according to claim 1, wherein the optimized driving routes are calculated by the external control entity and transmitted to each of the plurality of motor vehicles via a wireless communication network; and
wherein the optimized driving routes are calculated by an internal control unit of each of the plurality of motor vehicles.

3. The method according to claim 1, wherein each of the plurality of motor vehicles transmits the navigation data or the emission data to the external control entity via the wireless communication network.

4. The method according to claim 1, wherein the external control entity transmits information about the calculated immission load to each of the plurality of motor vehicles via the wireless communication network.

5. The method according to claim 1, wherein the optimized driving routes of the motor vehicles are calculated by taking into account at least one of a variable operation mode of each of the plurality of motor vehicles and a battery status of a traction battery of the each of the plurality of motor vehicles.

6. The method according to claim 5, wherein the plurality of motor vehicles are provided with an optimized operation scheme to be followed on the optimized driving route.

7. The method according to claim 1, wherein the optimized driving routes of the plurality of motor vehicles are calculated to minimize the immission load or to keep the immission load below a predefined threshold at least in predefined emission zones of the street network.

8. A system for regulating traffic emissions across a street network), the system comprising:
an external control entity configured to calculate a real-time location-dependent immission load across the street network based on at least one of environmental data, traffic data, and configuration data of the street network; and
a plurality of motor vehicles using the street network, each of the plurality of motor vehicles being configured to provide navigation data characterizing a route of each of the plurality of motor vehicles along the street network, and emission data characterizing exhaust emission levels of each of the plurality of motor vehicles along a route;
wherein the external control entity is configured to calculate an optimized driving route for each of the plurality of motor vehicles along the street network based on the calculated immission load and the emission data of the plurality of motor vehicles, and to transmit the optimized driving routes to each of the plurality of motor vehicles via a wireless communication network; or
wherein an internal control unit of each of the plurality of motor vehicles is configured to calculate an optimized driving route for each of the plurality of motor vehicles along the street network based on the calculated immission load and the emission data of the plurality of motor vehicles.

9. The system according to claim 8, wherein the external control entity is configured to calculate an optimized driving route for each of the plurality of motor vehicles along the street network based on the calculated immission load and the emission data of the plurality of motor vehicles, and to transmit the optimized driving routes to each of the plurality of motor vehicles via a wireless communication network; and
wherein an internal control unit of each of the plurality of motor vehicles is configured to calculate an optimized driving route for each of the plurality of motor vehicles along the street network based on the calculated immission load and the emission data of the plurality of motor vehicles.

10. The system according to claim 8, wherein each of the plurality of motor vehicles is configured to transmit the navigation data or the emission data to the external control entity via the wireless communication network.

11. The system according to claim 8, wherein the external control entity is configured to transmit information about the calculated immission load to each of the plurality of motor vehicles via the wireless communication network.

12. The system according to claim 8, wherein the optimized driving routes of the plurality of motor vehicles are calculated taking into account at least one of a variable operation mode of each of the plurality of motor vehicles, and a battery status of a traction battery of each of the plurality of motor vehicles.

13. The system according to claim 12, wherein the plurality of motor vehicles are provided with an optimized operation scheme to be followed on the optimized driving route.

14. The system according to claim 8, wherein the optimized driving routes of the plurality of motor vehicles are calculated to minimize the immission load or to keep the immission load below a predefined threshold at least in predefined emission zones of the street network.
